(19) United States
(12) Patent Application Publication
(10) Pub. No.: US 2015/0135782 A1
(43) Pub. Date: May 21, 2015

(54) PUSH BUTTON LOCK

(71) Applicant: Hansen International, Inc., Lexington, SC (US)

(72) Inventors: Dennis J. Sadler, Blythewood, SC (US); William H. Poteat, Ridgeway, SC (US)

(21) Appl. No.: 14/513,565

(22) Filed: Oct. 14, 2014

Related U.S. Application Data
(60) Provisional application No. 61/899,581, filed on Nov. 4, 2013.

(51) Int. Cl. E05B 57/00

(52) U.S. Cl. CPC E05B 57/00
USPC 70/344

(57) ABSTRACT

A push button lock assembly includes a tray, a button member slidably mounted to the tray, and a securing mechanism is mounted to the back side of the tray movable between a first position and a second position. A locking assembly is mounted to the button member and movable from a locked position to an unlocked position. When the locking assembly is locked, the connection between the button member and the securing mechanism is disconnected.

### RELATED APPLICATIONS

This application claims filing benefit of United States Provisional Patent Application Ser. No. 61/899,581 having a filing date of Nov. 4, 2013, which is incorporated herein by reference in its entirety.

### TECHNICAL FIELD

The present disclosure relates to a push button lock assembly that can be used, for example, on a vehicle box lid or compartment door.

### BACKGROUND

Truck boxes and compartments with openable lids or doors have latching assemblies to allow them to be opened and closed as desired. Often a paddle handle assembly is used in such location having a paddle handle pivotally mounted in a housing such as a tray. To open the lid/door, the user grabs and pivots the handle relative to the housing to actuate and release some form of a securing mechanism on the inside of the box/compartment. Many types of securing mechanisms have been employed, such as rotary latches, pivoting latches, sliding latches, etc.

Such handle assemblies often incorporate a key cylinder to provide a locking feature to maintain the securing mechanism in the secured condition. With many of such handle assemblies, turning the key to the locked position moves a member on the inside of the box/compartment into a position blocking movement of the handle. In other words, when the device is locked, the handle cannot be pivoted or rotated because it is blocked from movement by the blocking member. The securing mechanism therefore is not movable from its secured position, and the lid/door cannot be opened.

Use of extreme force (such as by a criminal via a pry bar or the like) on such a handle assembly could result in overcoming or breaking the blocking member. If so, the device may be in some cases openable via movement of the handle to move the securing mechanism from the secured position to an opened position regardless of the fact that the key cylinder is in the locked position. Alternatively, the handle or other elements could be broken by the extreme force, while yet maintaining the assembly (and correspondingly the lid/door) in a locked position. Whether the box/compartment is compromised, the handle assembly may be damaged in such a “brute-force” attempt to overcome the lock.

Other paddle handle assemblies such as those disclosed in U.S. Pat. No. 5,941,104 include a disconnect feature, in which the paddle handle is freely pivotable over its normal range (rather than blocked from movement) when the device is locked. In such devices, the securing mechanism on the inside of the device may be isolated from the handle movement when the key cylinder is in the locked position. If extreme force were used to attempt to pry open this type of handle assembly, the isolation of the securing mechanism prevents the device from being opened, regardless of whatever damage may occur to the handle components. Therefore, a paddle handle device with a disconnect feature can be more secure, but still may be subject to damage in extreme situations.

Accordingly, a locking mechanism for vehicle boxes or compartments that addresses one or more of the drawbacks of existing devices, and/or a locking mechanism that provides other benefits to a user, would be welcome.

### SUMMARY

According to certain aspects of the disclosure, a push button lock assembly is disclosed for engaging a catch. The assembly may include a tray having a front side and a back side, the front side defining a cavity. A button member is slidably mounted to the tray at least partially within the cavity so that the button member is movable either in a first direction into the cavity or in a second direction opposite the first direction. A spring member urges the button member in the second direction. A latching member is pivotally mounted to the back side movable between a first position and a second position. The latching member is configured for engaging the catch in the first position and for releasing the catch in the second position. A locking assembly is mounted to the button member and has a drive arm, the locking assembly movable from a locked position where the drive arm is in a clear position to an unlocked position where the drive arm is in a drive position. A drive pin is engageable by the drive arm when the drive arm is in the drive position and the button member is moved in the first direction thereby pivoting the latching member from the first position toward the second position. The drive pin is spaced from the drive arm when the drive arm is in the clear position and the button member is moved in the first direction thereby maintaining the latching member in the first position. Various options and modifications are possible.

According to certain other aspects of the disclosure, a push button lock assembly for engaging a catch may include a tray having a front side and a back side, the front side defining a cavity. A button member is slidably mounted to the tray at least partially within the cavity so that the button member is movable either in a first direction into the cavity or in a second direction opposite the first direction. A securing mechanism is mounted to the back side movable between a first position and a second position. The securing mechanism is configured for engaging the catch in the first position and for releasing the catch in the second position. A locking assembly is mounted to the button member and is movable from a locked position to an unlocked position. A disconnect drive mechanism between the button member and the securing mechanism is configured so that when the locking assembly is in the unlocked position the button member is movable from the first position to the second position the disconnect drive mechanism also connected so as to move the securing mechanism from the first position to the second position. The disconnect drive mechanism is also configured so that when the locking assembly is in the locked position the button member is movable from the first position to the second position but the disconnect drive mechanism is disconnected so as to be unable to move the securing mechanism from the first position to the second position. Various options and modifications are possible.

According to certain other aspects of the invention, a push button lock assembly for engaging a catch may include a tray having a front side and a back side, the front side defining a cavity. A button member is slidably mounted to the tray at least partially within the cavity so that the button member is movable either in a first direction into the cavity or in a second direction opposite the first direction. A securing mechanism is mounted to the back side movable between a first position and a second position. The securing mechanism is configured for engaging the catch in the first position and for releasing the catch in the second position. A locking assembly is mounted to the button member and movable from a locked position to an unlocked position. A structure is provided for moving the securing mechanism from the first position toward the second position when the button member is moved in the first direction while the locking assembly is in the unlocked position. A structure is also provided for maintaining the securing mechanism in the first position when the button member is moved in the first direction while the locking assembly is in the locked position. Various options and modifications are possible.

### BRIEF DESCRIPTION OF THE DRAWINGS

More details of the present disclosure are set forth in the drawings.

FIG. 1 is a front perspective view of a push button lock assembly contacting a catch according to certain aspects of the invention;

FIG. 2 is a rear perspective view of the push button lock assembly of FIG. 1;

FIG. 3 is a rear view of the push button lock assembly hand of FIG. 1;

FIG. 4 is an exploded rear perspective view the push button lock assembly of FIG. 1;

FIG. 5 is a rear view of a button member portion of the push button lock assembly of FIG. 1, showing the lock and drive member in a locked position;

FIG. 6 is a rear view of a button member portion of the push button lock assembly of FIG. 1, showing the lock and drive member in an unlocked position

FIG. 7 is a side view of the push button lock assembly of FIG. 1, showing the device in an unlocked, actuated, secured position;

FIG. 8 is a side view of the push button lock assembly of FIG. 1, showing the device in an unlocked, actuated, opened position;

FIG. 9 is a side view of the push button lock assembly of FIG. 1, showing the device in an locked, actuated, secured position; and

FIG. 10 is a cross-sectional view through the push button lock assembly as above, in the orientation shown in FIG. 7, taken along line 10-10 of FIG. 3.

### DETAILED DESCRIPTION

Detailed reference will now be made to the drawings in which examples embodying the present disclosure are shown. The detailed description uses numeral and letter designations to refer to features in the drawings. Like or similar designations in the drawings and description have been used to refer to like or similar parts of the disclosure.

The drawings and detailed description provide a full and enabling description of the disclosure and the manner and process of making and using it. Each embodiment is provided by way of explanation of the subject matter not limitation thereof. In fact, it will be apparent to those skilled in the art that various modifications and variations may be made to the disclosed subject matter without departing from the scope or spirit of the disclosure. For instance, features illustrated or described as part of one embodiment may be used with another embodiment to yield a still further embodiment.

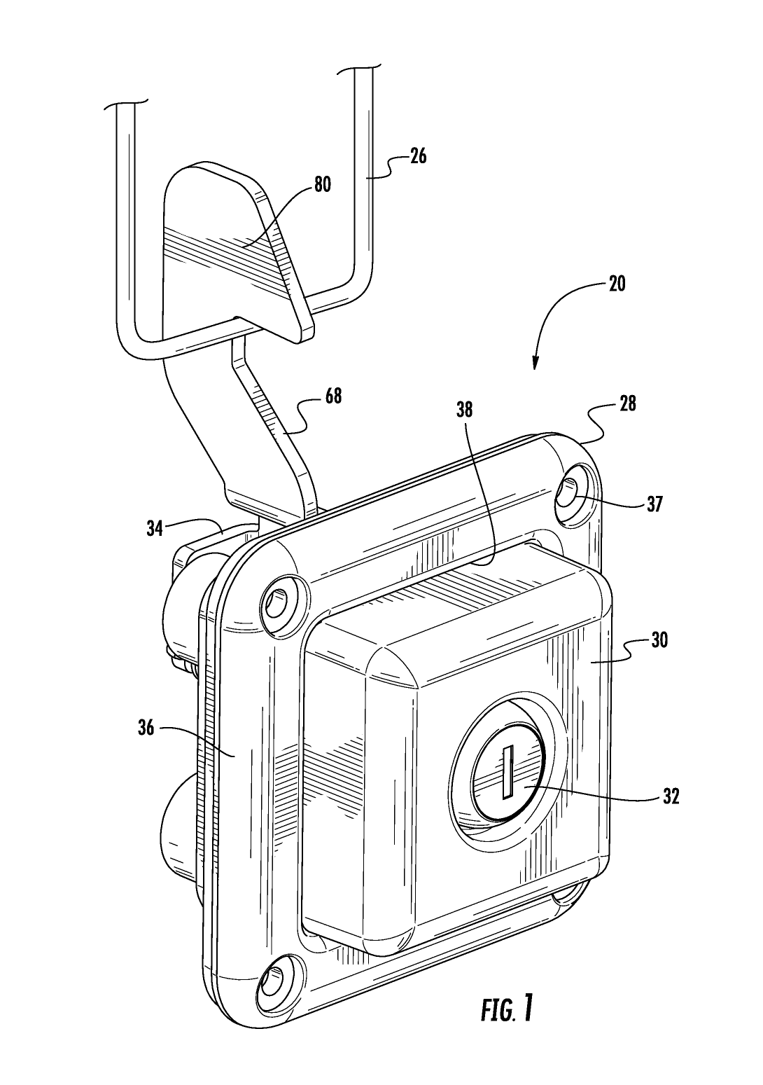

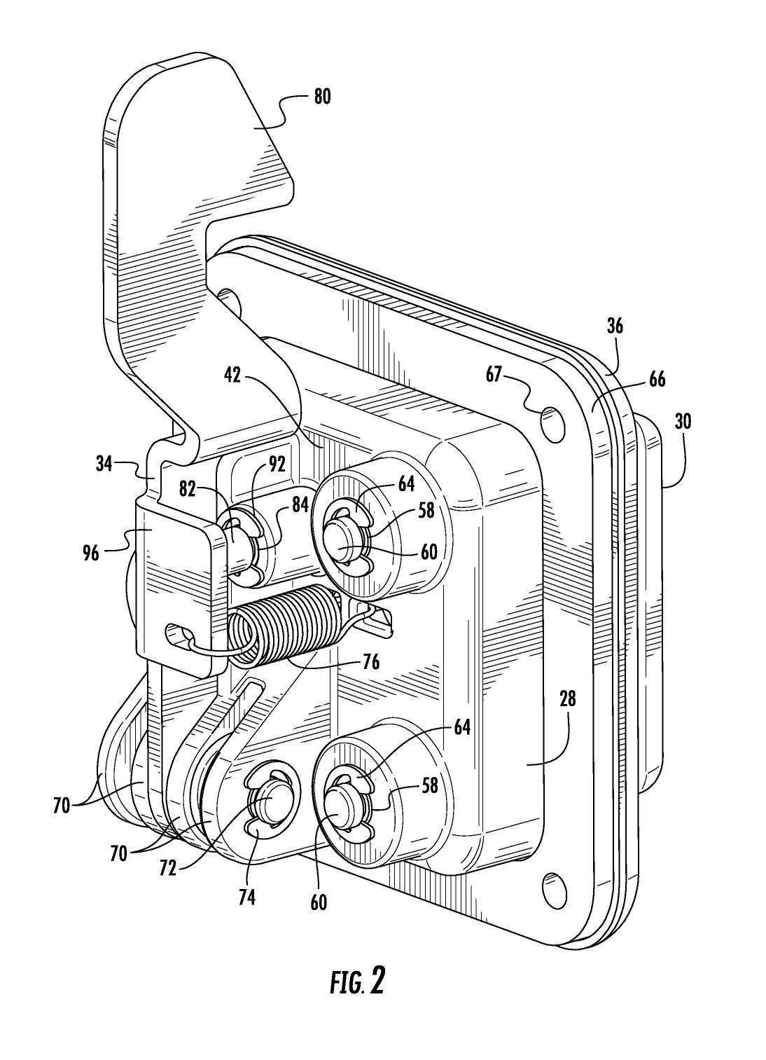

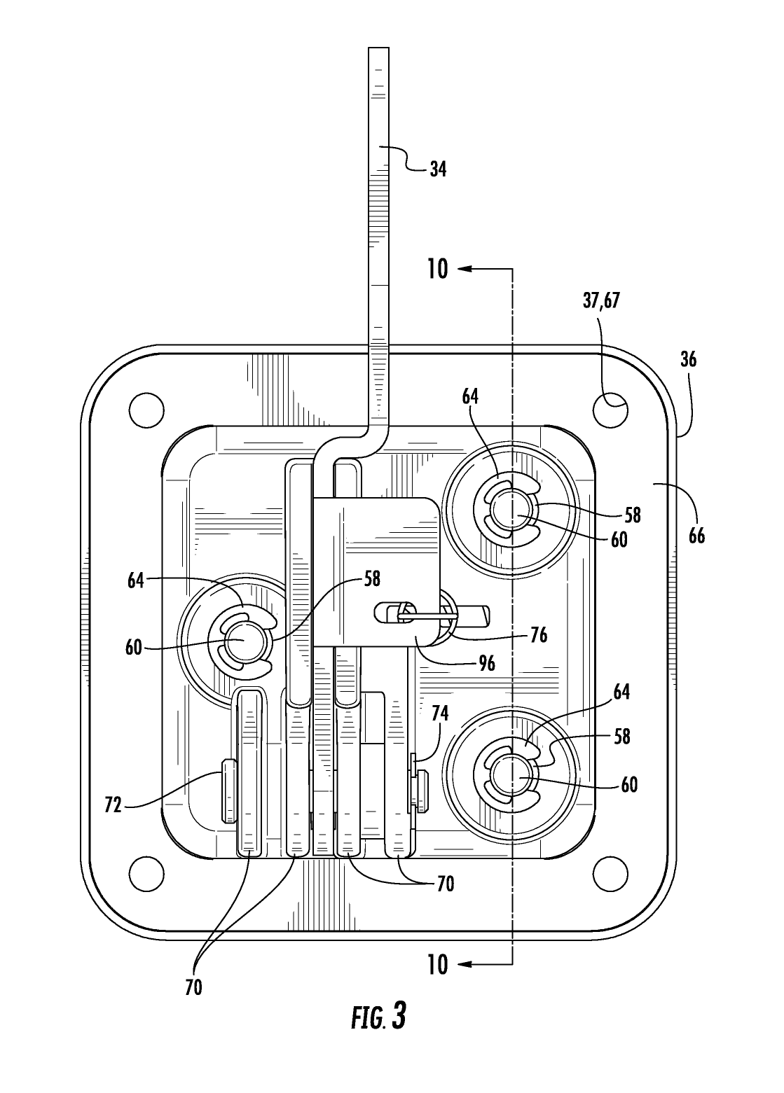

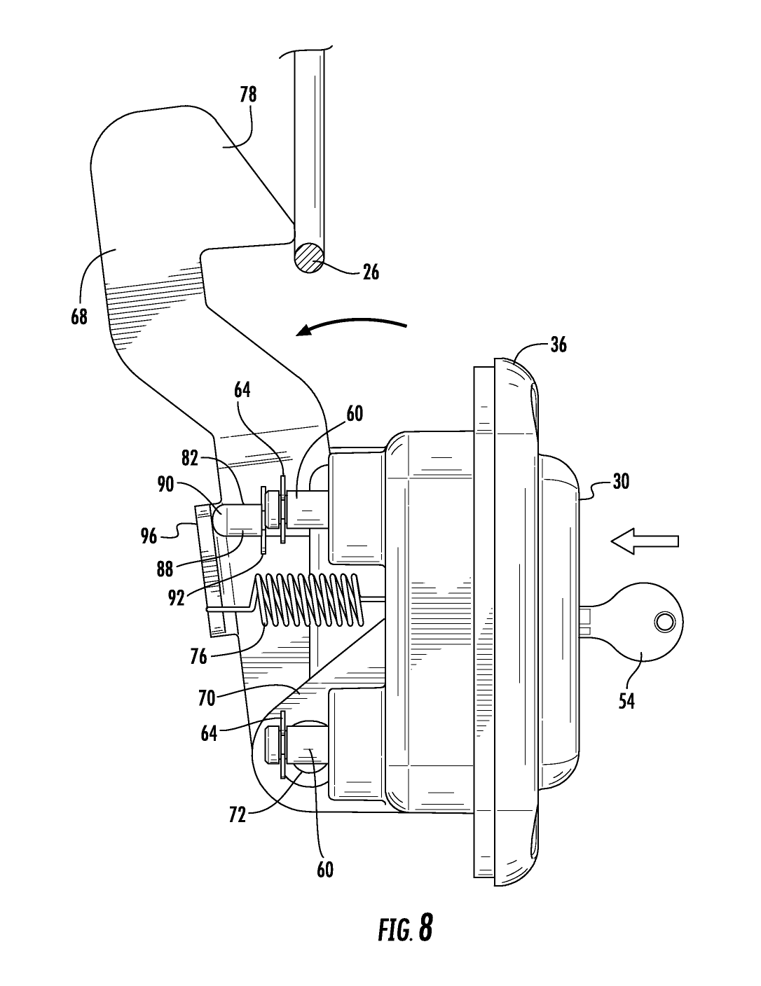

Generally speaking, FIGS. 1-10 depict one embodiment of a push button lock assembly 20 with a disconnect feature. Assembly 20 is made for attachment to one surface 22 for securing a relatively movable surface 24 (see FIG. 7) having an engaging element such as a catch 26, which can have many shapes. Accordingly, assembly 20 may be mounted on a box such as a truck box for engaging a catch on a lid, or vice versa. Alternatively, assembly 20 may be mounted on a compartment exterior panel for engaging a catch on a door, or vice versa. Accordingly, there should be no limitation understood as far as the application of assembly 20 to selectively allow opening or closing of two relatively movable elements.

As shown, assembly 20 includes a tray 28, a button member 30, a locking assembly 32 attached to the push button, and a securing mechanism 34. Tray 28 defines a flange 36 surrounding a cavity 38 sized for receiving the button member 30 on a first side 40 of the tray. The securing mechanism is attached to a second side 42 of the tray. Tray 28 may be formed of a plastic resin, such as a glass fiber reinforced Nylon 6.

Button member 30 as shown is substantially square in perimeter, matching the exterior shape of cavity 38. Button member 30 is slidably mounted to tray 28 at least partially within cavity 38 so that the button member is movable either in a first direction into the cavity or in a second direction opposite the first direction. If desired a seal member such as an O-Ring 44 or the like is mounted in a slot 46 in button member 30 (or tray cavity 38) to prevent or at least reduce entry of exterior moisture and debris from outside of assembly 20 from reaching second side 42 of tray 28.

As illustrated, button member 30 defines a cavity 48 facing tray cavity 38. Lock assembly 20 includes a lock cylinder 50 located through an opening 52 in button member and secured there, for example by a nut 55. Lock cylinder 50 is actuatable by key 54 in conventional fashion. A drive member 56 is fixedly attached to lock cylinder 50 (by a screw, brad, weld, etc.) so as to rotate with key 54 when turned. Lock cylinder 50 as shown rotates 90 degrees, but no limitation should be understood as to the amount or direction of rotation. As will be described below, drive member 56 when moved by the key can move from a drive position to a clear position as part of the disconnect function.

Structure is provided to guide button member 30 in linear movement back and forth into cavity 38. As illustrated, tray 28 defines plurality of bosses 58, and a plurality of guide rods 60 extend from button member 30 through the bosses. As illustrated, three such sets of bosses 58 and rods 60 are provided. Using multiple boss/rod elements provides a smoother, more reliable motion of button member 30. As shown, boss/rod structures are spread apart in a triangle, coverage top-to-bottom and side-to-side coverage of button member 30 within cavity 38. However, other numbers of boss/rod combinations and other orientations are possible. If desired, guide rods 60 may be pre-formed, for example of 1018 steel, and button member 30 may be an alloy such as Zamak 5 cast about the guide rods to make a unitary assembly. Such manufacture provides a strong piece (button member plus rods) and requires fewer assembly steps than screwing or otherwise attaching the rods to the button member. However, a cast and/or unitary construction is not required.

At least one spring member is provided to urge button member 30 in a direction out of cavity 38. As shown, three spring members 62 are provided, each disposed around a respective one of the guide rods 60 between front side 40 of tray 28 and button member 30. It would alternatively be possible to place a spring member (not shown) on second side 42 of tray for urging drive rods 60 (and accordingly button member 30) in the same direction. Holding elements such as clips 64 are attached to the ends of guide rods 60 on back side 42 of tray 28 to hold button member 30 to the tray. Clips 64 essentially act as a stop, preventing spring members 62 from pushing button member 30 out of tray 28. To operate the assembly, a user pushes button member 30 in a direction to oppose (and thereby compress, as shown) spring members 62 so as to push the button member further into the cavity 38.

On second (back) side 42 of tray 28, a conventional seal member (such as a gasket or the like) 66 may be located behind flange 36 for sealing between the flange and the mounting surface 22. Holes 37 and 67 in flange 36 and gasket 66, respectively, may receive screws, rivets, etc. for mounting the assembly to surface 22 as is conventinal. Securing mechanism 34 in this example includes a pivotal latching member 68 pivotally mounted to raised bosses 70 on tray 28 via a pivot pin 72 through hole 73 and clip 74. A spring member 76 urges latching member 68 toward a first position (shown in FIG. 7). Latching member 68 as illustrated includes a hook 78 for engaging catch 26. Hook 78 may have a slanted top surface 80 to allow the door/lid to be slammed when in the first position, latching member 68 pivoting and stretching spring member 76 and then returning during this motion without having to pushing in button member 30. Accordingly, the lid/door can be closed (slammed) regardless of whether lock cylinder 50 is in a locked position. However, it should be understood that pivotable latching member 68 is but one type of securing mechanism 34 suitable for use. Accordingly, slidable, rotatable, or rotary mechanisms could be used. Further, the latching member 68 could be mounted so as to pivot around an axis perpendicular to that of pivot pin 72. Therefore, various types of securing mechanisms could be employed in the present device.

Drive pin 82 is provided so as to be movable with button member 30 when the lock cylinder 50 is in the unlocked position. Drive pin 82 is not moved when lock cylinder 50 is in the locked position. As illustrated, drive pin 82 extends through a boss 84 in tray 28. A first end 86 of drive pin 82 is located on tray first side 40 within cavity 38 and a second end 88 is located on tray second side 42. Second end 88 may have a rounded tip 90. Drive pin 82 may be may be held in place by a clip 92 which provides a motion limit, as above.

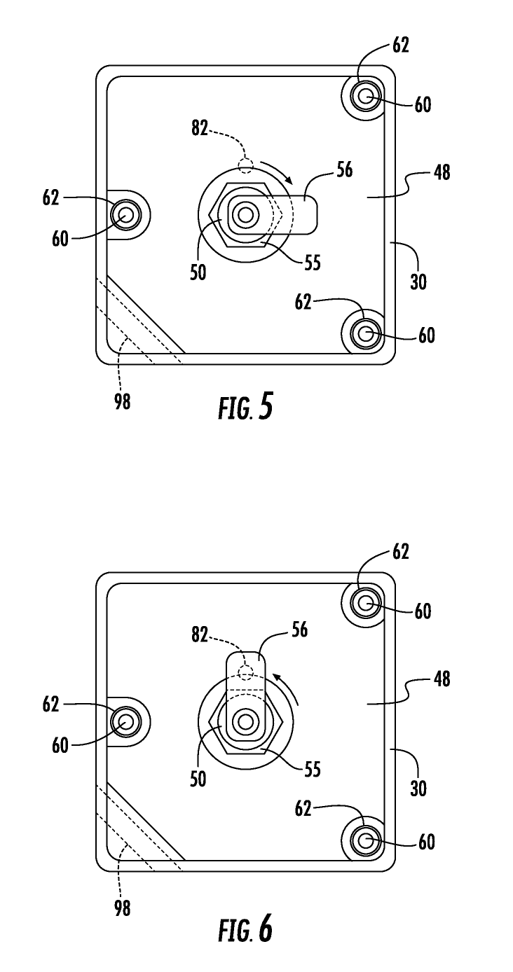

FIG. 5 shows the position of drive pin 82 when lock cylinder 50 is in the locked position. Note drive member 56 extends laterally (as shown) and is in a position clear of drive pin 82. Accordingly, if button member 30 is pressed into tray cavity 38 with drive member 56 in this orientation, drive pin 82 is not contacted.

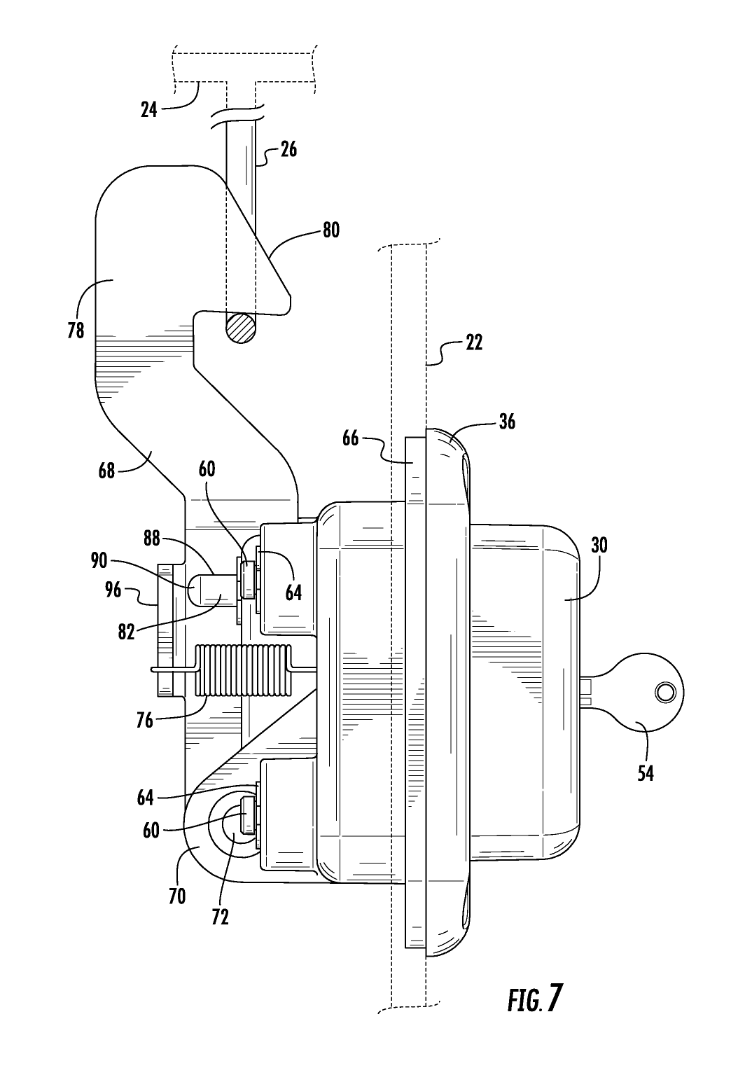

FIG. 6 shows lock cylinder 50 in an unlocked position. As illustrated, drive member 56 extends upward and is aligned in a drive position relative to drive pin 82. Accordingly, if button member 30 is pushed inwardly, drive member 56 will contact and push first end 86 of drive pin 82 inwardly as well. Drive pin 82 will slide within drive boss 84, and rounded tip 90 of second end 88 will contact and actuate the securing mechanism 34. Drive pin 82 should have a length from clip 92 to the first end 86 slightly less that the distance to drive member 56, so that lock cylinder 50 may be turned freely without interference from drive pin 82. Therefore, first end 86 is axially spaced from drive member 56 in an inward direction when clip 92 at second end 88 contacts back side 42 of the tray 28.

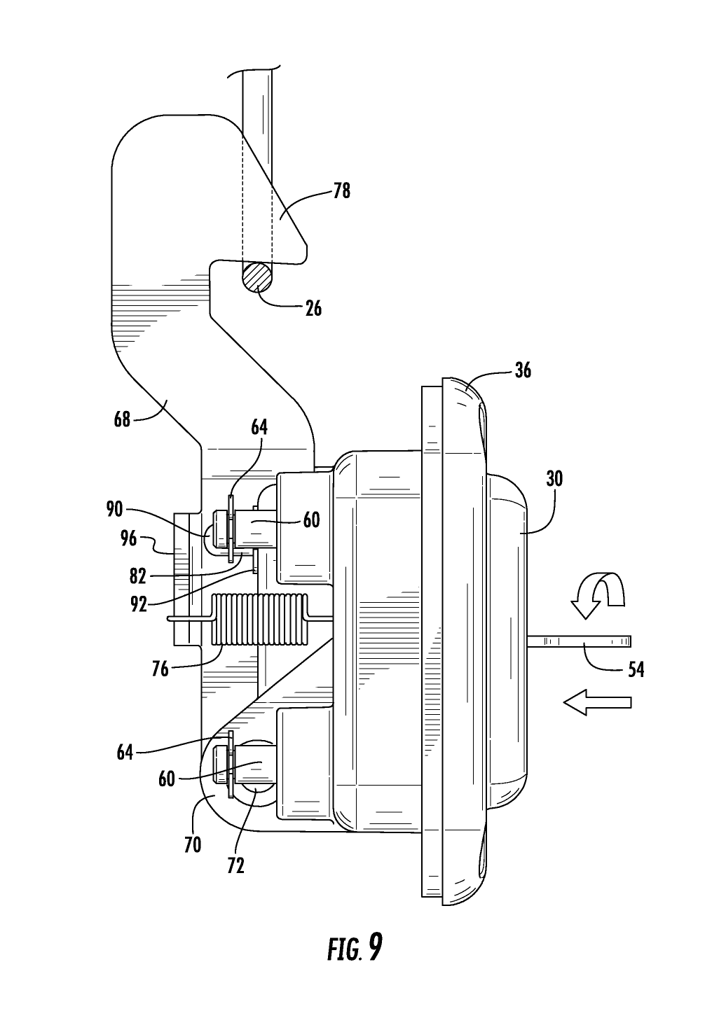

As illustrated, latching member 68 includes a camming arm 96 contactable by tip 90 for contacting and actuating camming arm 96 of the latching member to pivot and stretch spring member 76. The rounded shape of tip 90 helps maintain smooth contact with camming arm 96 as latching member 68 is pivoted from the position of FIG. 7 to that of FIG. 8 when the lock cylinder is in the unlocked position (FIG. 6).

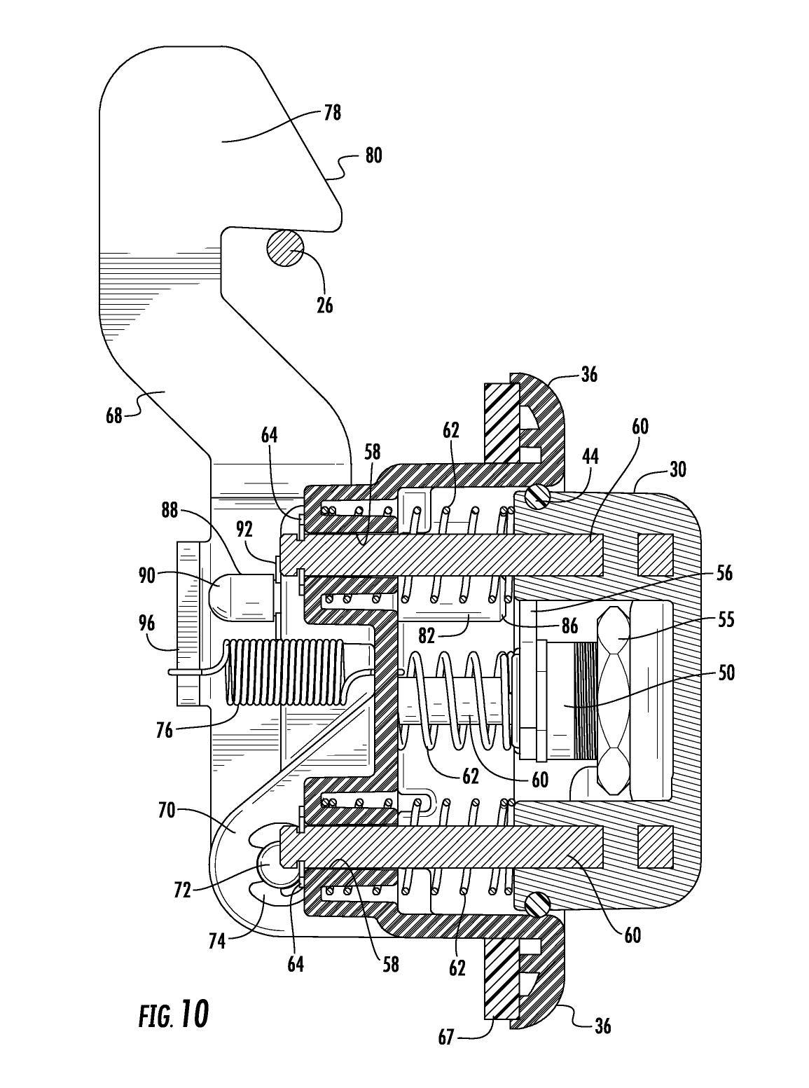

However, if locking cylinder 50 is in the locked position (FIG. 5), movement of button member 30 inwardly moves the button member and guide rods 60 but not drive pin 82. Therefore, when locking cylinder 50 is in the locked position, pushing button member 30 inwardly moves the device from the position of FIG. 7 instead to that of FIG. 9.

A disconnect drive mechanism feature is thus provided wherein the actuator used by the operator (i.e., button member 30) is movable when the device is locked, but damage to internal parts is extremely unlikely as the lock cylinder and drive pin are not engageable. Such is particularly the case here with a push button style lock, as compared to a paddle handle. The structure immediately above can also be said to provide a means for moving the securing mechanism from the first position toward the second position when the button member is moved in the first direction while the locking assembly is in the unlocked position, as well as a means for maintaining the securing mechanism in the first position when the button member is moved in the first direction while the locking assembly is in the locked position.

It would be possible to modify the lock cylinder/drive pin/latch member interconnections in some ways pursuant to the present disclosure. For example, the drive pin could be mounted for movement with the lock cylinder. If so, the drive boss would have to be made into an arcuate slot and the latching member configured to receive the drive pin in the unlocked position but not the locked position. Other modifications within the scope and spirit of the above disclosure and following claims are also possible.

Regardless of how the above disclosure is utilized, the exterior of the resulting assembly is secure, as no exterior moving parts are used (such as in paddle handles or the like) under which one could insert a pry bar. The present assembly is thus particularly secure.

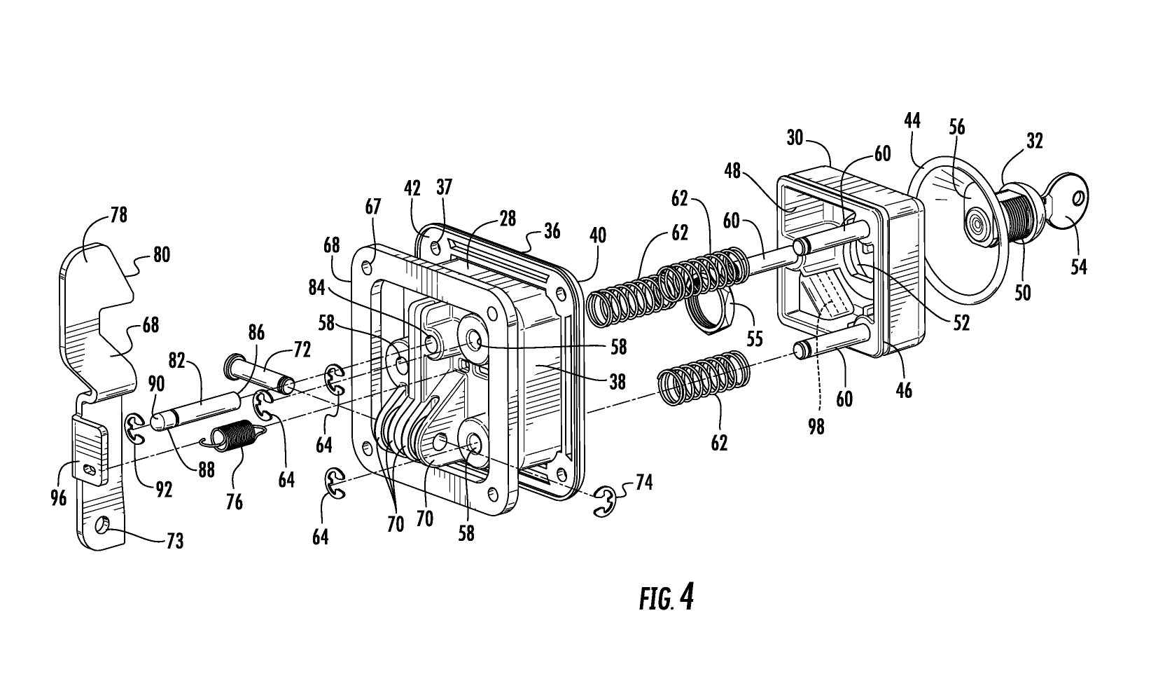

If desired, an even further locking structure can be provided. As shown, a passageway 98 can be defined though a portion of button member 30 outside of cavity 38 (see FIGS. 4-7) sized large enough to receive a locking member, such as a padlock, combination lock or other secure lock structure. With such additional lock element in place in passageway 98, button member 30 cannot be appreciably pushed inwardly into cavity 38 as such additional lock element would hit tray flange 36 stopping inward motion of the button member. Thus, almost no moving parts are available to a person trying to use brute force to open the assembly, and an extremely secure assembly is provided.

While preferred embodiments of the invention have been described above, it is to be understood that any and all equivalent realizations of the present invention are included within the scope and spirit thereof. Thus, the embodiments depicted are presented by way of example only and are not intended as limitations upon the present invention. Thus, while particular embodiments of the invention have been described and shown, it will be understood by those of ordinary skill in this art that the present invention is not limited thereto since many modifications can be made. Therefore, it is contemplated that any and all such embodiments are included in the present invention as may fall within the literal or equivalent scope of the appended claims.

We claim:

1. A push button lock assembly for engaging a catch, comprising:
a tray having a front side and a back side, the front side defining a cavity;
a button member slidably mounted to the tray at least partially within the cavity so that the button member is movable either in a first direction into the cavity or in a second direction opposite the first direction;
a spring member for urging the button member in the second direction;
a latching member pivotally mounted to the back side movable between a first position and a second position, the latching member configured for engaging the catch in the first position and for releasing the catch in the second position;
a locking assembly mounted to the button member and having a drive arm, the locking assembly movable from a locked position where the drive arm is in a clear position to an unlocked position where the drive arm is in a drive position; and
a drive pin being engageable by the drive arm when the drive arm is in the drive position and the button member is moved in the first direction thereby pivoting the latching member from the first position toward the second position, the drive pin being spaced from the drive arm when the drive arm is in the clear position and the button member is moved in the first direction thereby maintaining the latching member in the first position.

2. The push button lock assembly of claim 1, wherein the tray defines plurality of bosses, and wherein a plurality of guide rods extend from the button member through the bosses to guide movement of the button member in the first and second directions.

3. The push button lock assembly of claim 2, the assembly including three of the bosses and three of the guide rods.

4. The push button lock assembly of claim 2, wherein the spring member comprises a plurality of spring members, each spring member being disposed around a respective one of the guide rods between the front side of the tray and the button member.

5. The push button lock assembly of claim 4, further including clips on the back side of the tray attached to the guide rods to secure the guide rods and the button member to the tray.

6. The push button lock assembly of claim 1, wherein the tray defines a drive boss, and the drive pin is located in the drive boss.

7. The push button lock assembly of claim 6, wherein the drive pin has a first end and a second end, the assembly further including a clip on the back side of the tray attached to the second end of the drive pin to secure the drive pin to the tray.

8. The push button lock assembly of claim 7, wherein the drive pin has a length so that the first end is axially spaced from the drive member when the clip at the second end of the drive pin contacts the back side of the tray.

9. The push button lock assembly of claim 8, wherein the latching member includes a camming arm contactable by the second end of the drive pin to move the latching member toward the second position.

10. The push button lock assembly of claim 1, further including a sealing member between the cavity and a perimeter of the button member.

11. The push button lock assembly of claim 1, wherein the cavity and the button member are substantially square.

12. The push button lock assembly of claim 1, wherein the latching member is urged toward the first position by a spring member extending between the latching member and the tray.

13. The push button lock assembly of claim 1, wherein the button member defines an opening therethrough configured for receipt of a supplemental locking element.

14. A push button lock assembly for engaging a catch, comprising:
a tray having a front side and a back side, the front side defining a cavity;
a button member slidably mounted to the tray at least partially within the cavity so that the button member is movable either in a first direction into the cavity or in a second direction opposite the first direction;
a securing mechanism mounted to the back side movable between a first position and a second position, the securing mechanism configured for engaging the catch in the first position and for releasing the catch in the second position;
a locking assembly mounted to the button member and movable from a locked position to an unlocked position; and
a disconnect drive mechanism between the button member and the securing mechanism, the disconnect drive mechanism configured so that when the locking assembly is in the unlocked position the button member is movable from the first position to the second position and the disconnect drive mechanism is connected so as to move the securing mechanism from the first position to the second position, the disconnect drive mechanism also configured so that when the locking assembly is in the locked position the button member is movable from the first position to the second position but the disconnect drive mechanism is disconnected so as to be unable to move the securing mechanism from the first position to the second position.

15. The push button lock assembly of claim 14, wherein the disconnect drive mechanism includes a drive arm rotatably mounted on the locking assembly and a drive pin slidably mounted to the tray, the drive pin having an axial length so as to provide clearance of the drive arm when the locking assembly is rotated.

16. The push button lock assembly of claim 14, further including a plurality of guide rods extending from the button member through the tray to guide movement of the button member into our out of the cavity and a plurality of spring members, each spring member being disposed around a respective one of the guide rods between the front side of the tray and the button member for urging the button member in a direction out of the cavity.

17. The push button lock assembly of claim 14, wherein the securing mechanism includes a spring loaded latch urged toward the first position.

18. The push button lock assembly of claim 14, wherein the button member defines an opening therethrough configured for receipt of a supplemental locking element.

19. A push button lock assembly for engaging a catch, comprising:
a tray having a front side and a back side, the front side defining a cavity;
a button member slidably mounted to the tray at least partially within the cavity so that the button member is movable either in a first direction into the cavity or in a second direction opposite the first direction;
a securing mechanism mounted to the back side movable between a first position and a second position, the securing mechanism configured for engaging the catch in the first position and for releasing the catch in the second position;
a locking assembly mounted to the button member and movable from a locked position to an unlocked position; and
means for moving the securing mechanism from the first position toward the second position when the button member is moved in the first direction while the locking assembly is in the unlocked position, and means for maintaining the securing mechanism in the first position when the button member is moved in the first direction while the locking assembly is in the locked position.
